(19) United States
(12) Patent Application Publication
(10) Pub. No.: US 2008/0203747 A1
(43) Pub. Date: Aug. 28, 2008

(54) Serving utensil

(76) Inventor: William C. Stenglein, Grayling, MI (US)

Correspondence Address: JAMES RAY & ASSOCIATES, 2640 PITCAIRN ROAD, MONOROEVILLE, PA, 15146, US

(21) Appl. No.: 12/069,866

(22) Filed: Feb. 13, 2008

Related U.S. Application Data
(60) Provisional application No. 60/890,532, filed on Feb. 19, 2007.

(51) Int. Cl. A47G 21/04; A47J 43/28

(52) U.S. Cl. 294/7

(57) ABSTRACT

A serving utensil including a handle member, manufactured from a first predetermined material and having a first predetermined size and a first predetermined shape. A serving member, manufactured from a second predetermined material and having a second predetermined size and a second predetermined shape, is operably connected to such handle member. The serving member further includes at least one stationary portion operably connected to such handle member at a predetermined location thereon and a plurality of moveable segmented portions operably connected to the stationary portion at one end thereof for allowing the serving member to conform to a predetermined shape of a dish from which food is being removed.

### CROSS REFERENCE TO RELATED APPLICATION

This patent application is related to and claims priority from U.S. Provisional Patent Application Ser. No. 60/890,532 filed Feb. 19, 2007.

### FIELD OF THE INVENTION

The present invention relates, in general, to utensils and, more particularly, this invention relates to serving utensils.

### BACKGROUND OF THE INVENTION

Prior to the conception and development of the present invention, serving utensils, as are generally well known in the prior art, have been used to serve foods. However none are truly adapted to serve food from pie pans, tart pans and the like.

### SUMMARY OF THE INVENTION

The present invention provides a serving utensil. The serving utensil includes a handle member manufactured from a first predetermined material and having a first predetermined size and a first predetermined shape. A serving member, manufactured from a second predetermined material and having a second predetermined size and a second predetermined shape, is operably connected to such handle member. The serving member further includes at least one stationary portion operably connected to such handle member at a predetermined location thereon and a plurality of moveable segmented portions operably connected to the stationary portion at one end thereof for allowing the serving member to conform to a predetermined shape of a dish from which food is being removed.

### OBJECTS OF THE INVENTION

It is, therefore, one of the primary objects of the present invention to provide a serving utensil that will enable a user to easily serve food from pie pans, tart pans, and the like without such food being mangled as it is maneuvered from its dish.

Another object of the present invention is to provide an easy to use serving utensil that will enable a user to serve food more easily and conveniently than with traditional utensils.

Still another object of the present invention is to provide a serving utensil that will bend and conform to the contours of pie pans, tart pans, cake pans, circular pans and the like.

Yet another object of the present invention is to provide a serving utensil that will reduce the likelihood that the first slice of food removed from a dish will be broken and less aesthetically pleasing than the remaining pieces.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to a first embodiment.

FIG. 2 is a partial perspective view of the invention according to one embodiment in which the invention is being used to remove pie from a pie pan.

FIG. 3 is a partial plan view of the invention according to one embodiment.

FIG. 4 is a cross-sectional view of the invention along the lines of IV-IV.

FIG. 5 is a partial side view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

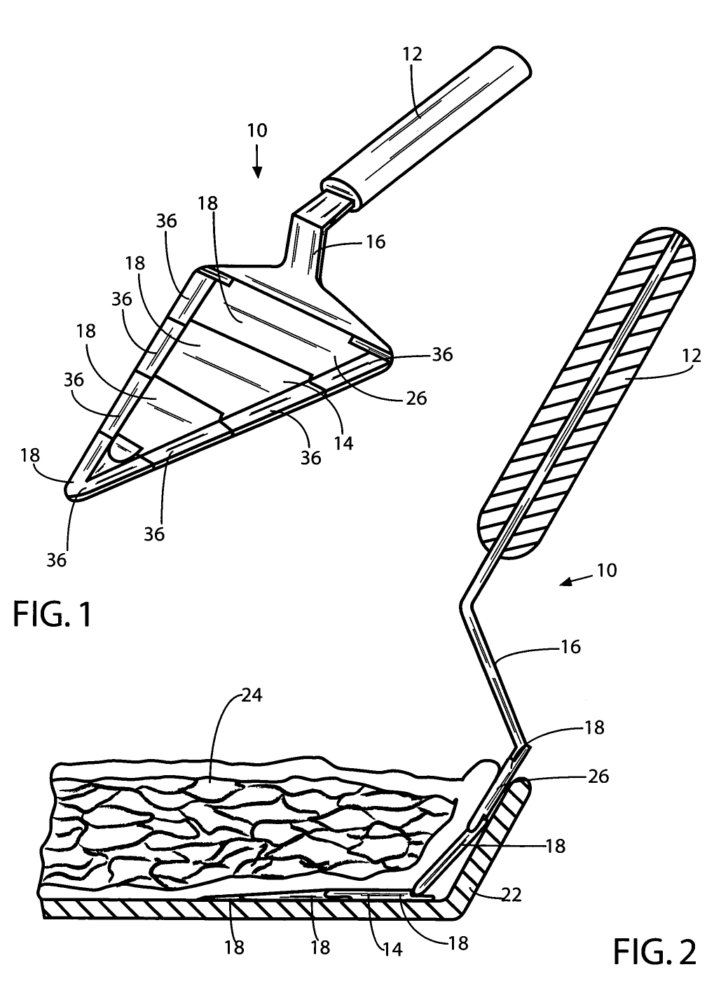

Reference is now made, more particularly, to FIGS. 1-5.

A serving utensil, generally designated 10, is provided. The serving utensil 10 includes a handle member 12. Such handle member 12 is manufactured from a first predetermined material and has a first predetermined size and a first predetermined shape. It is presently preferred that such first predetermined material is at least one of metal, plastic and wood. It is presently preferred that such first predetermined shape is substantially cylindrical.

A serving member 14, manufactured from a second predetermined material and having a second predetermined size and a second predetermined shape, is operably connected to the handle member 12. It is presently preferred that such second predetermined material is at least one of metal and plastic. It is further presently preferred that such second predetermined material is metal. It is presently most preferred that such second predetermined material is stainless steel. It is presently preferred that such second predetermined shape is substantially triangular.

The serving member 14 further includes at least one stationary portion 16 operably connected to the handle member 12 at a predetermined location thereon and a plurality of moveable segmented portions 18 operably connected to the stationary portion 16 at one end thereof for allowing the serving member 14 to conform to a predetermined shape of a dish 22 from which food 24 is being removed. It is presently preferred that the stationary member 16 is contoured such that the stationary member 16 conforms to a predetermined shape of such dish 22 from which food 24 is being removed.

Referring to FIG. 5, it is presently preferred that the stationary portion 16 is operably connected to a first moveable segmented portion 26 by at least one hinge 28. It is presently most preferred that the at least one hinge 28 is a fixed pin hinge.

Referring to FIG. 4 and FIG. 5, it is presently preferred that such plurality of moveable segmented portions 18 are operably connected in succession to each respective next segmented portion at a predetermined location thereon.

It is presently preferred that such plurality of moveable segmented portions 18 are connected to each successive moveable segmented portion by at least one hinge 28 at a predetermined location thereon. It is presently most preferred that the at least one hinge 28 is a fixed pin hinge.

As is clear from FIG. 2 the plurality of moveable segmented portions 18 may bend inward along their hinged connections during insertion into such dish 22 to conform to such dish 22 and slide easily under such food 24. However, as such food 24 is being lifted and removed from such dish 22 the plurality of moveable segmented portions 18 return to their original positions, as illustrated in FIG. 1 and FIG. 5 providing rigid support for such food 24 being removed from such dish 22.

It is presently preferred that such plurality of moveable segmented portions 18 are separable from at least one of each other and the stationary portion 16 for cleaning.

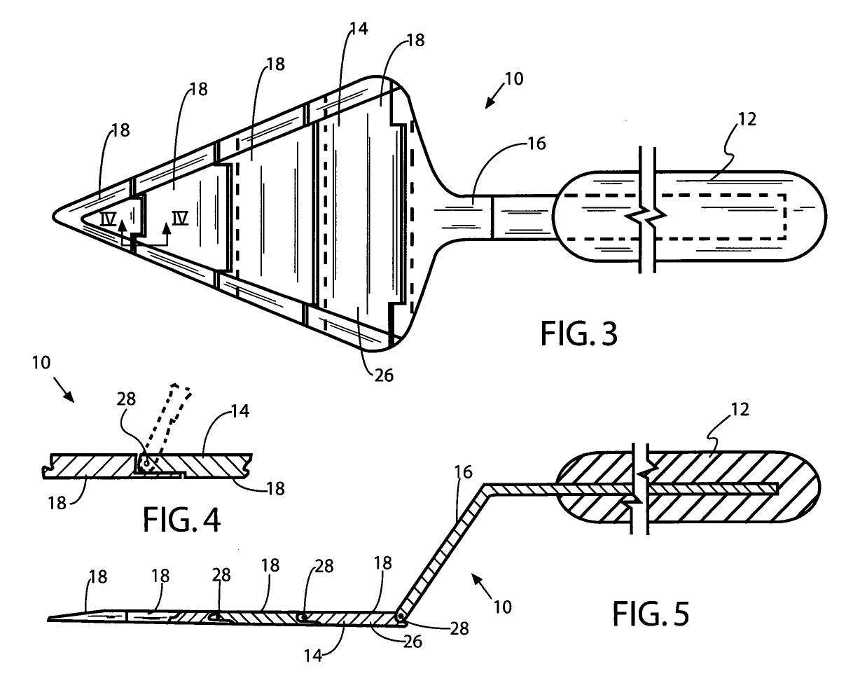

It is presently preferred that the serving member 14 includes at least four moveable segmented portions 18 as illustrated in FIG. 3. Referring to FIG. 1 and FIG. 3, it is further presently preferred that such plurality of moveable segmented portions 18 each include a beveled portion 36.

It is presently preferred that such plurality of moveable segmented portions 18 are each between about 0.5 inches and 3.0 inches wide. It is presently most preferred that such plurality of moveable segmented portions are each about 1.0 inches wide.

It is further presently preferred that such first predetermined material and such second predetermined material are substantially identical.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A serving utensil comprising;
a. a handle member being manufactured from a first predetermined material and having a first predetermined size and a first predetermined shape; and
b. a serving member, manufactured from a second predetermined material and having a second predetermined size and a second predetermined shape, operably connected to said handle member, said serving member further including;
i. at least one stationary portion operably connected to said handle member at a predetermined location thereon; and
ii. a plurality of moveable segmented portions operably connected to said stationary portion at one end thereof for allowing said serving member to conform to a predetermined shape of a dish from which food is being removed.

2. A serving utensil according to claim 1 wherein each of said plurality of moveable segmented portions are operably connected in succession to each respective next segmented portion at a predetermined location thereon.

3. A serving utensil, according to claim 2, wherein said plurality of moveable segmented portions are connected to each successive moveable segmented portion by a at least one hinge at a predetermined location thereon.

4. A serving utensil, according to claim 3, wherein said at least one hinge is a fixed pin hinge.

5. A serving utensil according to claim 1 wherein said stationary portion is operably connected to a first moveable segmented portion by at least one hinge.

6. A serving utensil, according to claim 5, wherein said at least one hinge is a fixed pin hinge.

7. A serving utensil, according to claim 1 wherein said plurality of moveable segmented portions are separable from at least one of each other and said stationary portion for cleaning.

8. A serving utensil, according to claim 1 wherein said serving member includes at least four moveable segmented portions.

9. A serving utensil, according to claim 1, wherein said first predetermined material is at least one of metal, plastic and wood.

10. A serving utensil, according to claim 1, wherein said second predetermined material is at least one of metal and plastic.

11. A serving utensil, according to claim 10, wherein said second predetermined material is metal.

12. A serving utensil, according to claim 11, wherein said metal is stainless steel.

13. A serving utensil, according to claim 1, wherein said first predetermined material and said second predetermined material are substantially identical.

14. A serving utensil, according to claim 1, wherein said first predetermined shape is substantially cylindrical.

15. A serving utensil, according to claim 1, wherein said second predetermined shape is substantially triangular.

16. A serving utensil, according to claim 1, wherein said plurality of moveable segmented portions each include a beveled portion.

17. A serving utensil, according to claim 1, wherein said plurality of moveable segmented portions are each between about 0.5 inches and 3.0 inches wide.

18. A serving utensil, according to claim 1, wherein said plurality of moveable segmented portions are each about 1.0 inches wide.

19. A serving utensil, according to claim 1, wherein said stationary member is contoured such that said stationary member conforms to a predetermined shape of a dish from which food is being removed.
